(19) United States
(12) Patent Application Publication
(10) Pub. No.: US 2021/0381306 A1
(43) Pub. Date: Dec. 9, 2021

(54) SECURITY DOOR

(71) Applicants: YOSEF POSTAVSKII, JERUSALEM (IL); ARON PRYS, JERUSALEM (IL); ARYE FRIEDNER, JERUSALEM (IL)

(72) Inventors: YOSEF POSTAVSKII, JERUSALEM (IL); ARON PRYS, JERUSALEM (IL); ARYE FRIEDNER, JERUSALEM (IL)

(21) Appl. No.: 17/336,375

(22) Filed: Jun. 2, 2021

(30) Foreign Application Priority Data
Jun. 7, 2020 (IL) 275165

(51) Int. Cl. E06B 3/70; E06B 5/10

(52) U.S. Cl. CPC E06B 3/7015; E06B 5/10; E06B 2003/7051; E06B 2003/7046; E06B 2003/703

(57) ABSTRACT

A security door, including two non-metal boards, two metal boards disposed between the two non-metal boards, and being fixed one to the other, while forming at least one gap therebetween, and a plurality of pins, each extending between the two non-metal boards, through the two metal boards, for fixing the two non-metal boards one to the other.

### CROSS-REFERENCE TO RELATED APPLICATIONS

This application claims the benefit of priority from Israel Patent Application No. 275165, filed Jun. 7, 2020, the disclosure of which is incorporated herein by reference.

### TECHNICAL FIELD

The invention relates to the field of security doors.

### BACKGROUND

There is a long felt need for a wooden security door, being a wooden door integrated with a steel chassis. This door is not produced due to difficulties in combining the wood with the metal and as below

1. Direct connection between the wood and metal is not possible due to differences in their low or high temperature expansion properties.

2. Wood connection to the metal by screws is made efficiently by connecting the wood to the single metal board and only then connecting the two parts of the metal. This causes deformation and warping of the metal since it is not sufficiently rigid.

3. Connection of the metal panels by welding or soldering being extremely difficult when the wood is connected to the metal.

U.S. Pat. No. 2,614,295 discloses a combination of wood and metal, wherein and however, the wood and the metal are fixed one to the other.

There is a long felt need to provide a solution to the above-mentioned and other problems of the prior art.

### SUMMARY

A security door, including:
two wood boards;
two metal boards disposed between the wood boards; and
pins, for fixing the wood boards one to the other.

### BRIEF DESCRIPTION OF THE DRAWINGS

Embodiments, features, and aspects of the invention are described herein in conjunction with the following drawings:

FIG. 1 is a perspective view of the elements for constructing a security door according to one embodiment of the invention.

FIG. 2 is a side view of the first step of constructing the security door of FIG. 1.

FIG. 3 is a side view of the second step of constructing the security door of FIG. 1.

FIG. 4 is a side view of the third step of constructing the security door of FIG. 1.

FIG. 5 is a side view of the fourth step of constructing the security door of FIG. 1.

FIG. 6 is a perspective view of the security door of FIG. 1 being constructed, shown cut for viewing its character.

FIG. 7 is a side view of the security door of FIG. 1 being constructed.

FIG. 8 magnifies a portion of FIG. 7.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

The term “security door” refers herein to a door being configured for avoiding burglary.

The terms “wood” and “non-metal” refer herein to wood, plastic, ceramic compound, organic compound, and to any material being significantly softer than metal.

The present invention relates to a door having a wood-metal connection means, containing a steel frame and steel or aluminum surfaces, which are connected to the frame by means of solder or clamps. Decorative wooden panels are attached to this building on both sides. The connection is made by means of wooden pins inserted through holes in the steel surfaces and connected to the drilled holes in the two wooden surfaces containing means for example adhesive, one-way mechanical gripper. The door lintel surfaces contain a locking mechanism whose bolt bars enter at the time of the door locking in the space between the two metal surfaces of the door and locking the door.

According to another configuration, an additional reinforcement for the metal connection to the wood will be provided by 90 degrees bending at the top of the metal surfaces and the wood connection also the top of the wood surfaces to this bending.

The current structure of the door allows for maximum mechanical strength of the door against break-in, a combination of metal and wood surfaces, a practical and beautiful wooden door design and the locking ability of a latching mechanism exiting the doorframe between two metal surfaces in the door.

The connection of the wooden boards is made after the connection of the metal boards and the shape of the connection bypasses the direct connection between the wood and the metal, so that the wood and metal are free to spread each according to their individual properties and still no disconnect in the connection between them.

Wooden rods are inserted through holes in the metal as the ends of the rod enter and are glued to the sockets in the wood moisture.

The door frame is bolted freely, and the metal can be punctured anywhere. The thickness of the door may be reduced in relation to any security door having a bolted body.

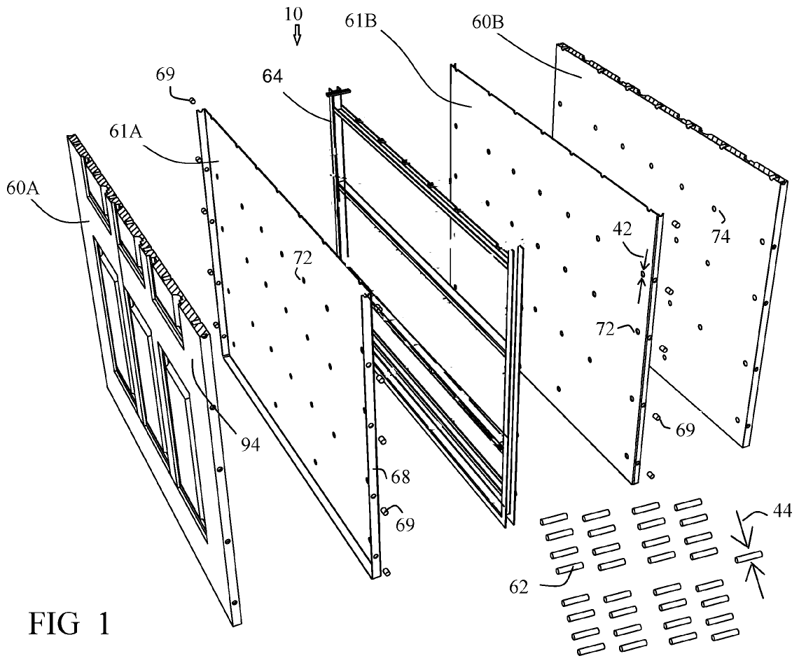

FIG. 1 is a perspective view of the elements for constructing a door according to one embodiment of the invention.

A security door 10 according to one embodiment, includes a metal frame 64; two metal boards 61A and 61B; two wood or other non-metal boards 60A and 60B; and a plurality of pins 62.

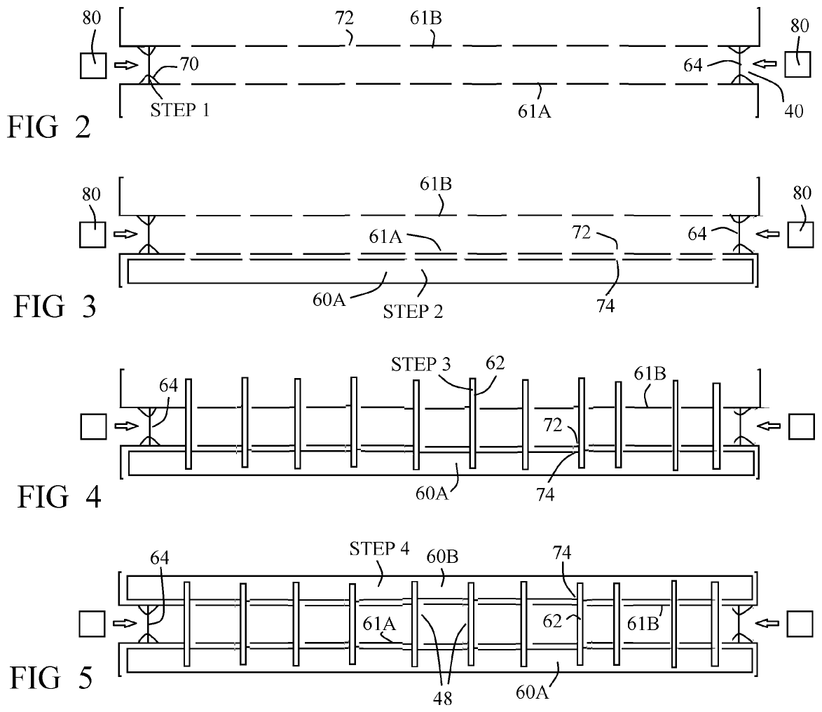

FIG. 2 is a side view of the first step of constructing the security door of FIG. 1.

At the first step, metal boards 61A and 61B are welded 70 to metal frame 64.

Metal frame 64 forms a gap 40 between metal boards 61A and 61B, thus allowing locking the security door to a lintel (not shown) by inserting an elongated bolt 80 in between.

However, yet, metal boards 61A and 61B might be resilient as being very thin.

FIG. 3 is a side view of the second step of constructing the security door of FIG. 1.

At the second step, wood board 60A is placed below metal board 61A.

FIG. 4 is a side view of the third step of constructing the security door of FIG. 1.

At the third step, pins 62 are inserted into holes 72 of metal board 61A, further into holes 72 of metal board 61B, and further forcibly stuck into depressions 74 of wood board 60A.

FIG. 5 is a side view of the fourth step of constructing the security door of FIG. 1.

At the fourth step, wood board 60B is placed above metal board 61B, by forcibly sticking pins 62, extending out, into depressions 74 of wood board 60B, being accompanied with wood glue.

Referring again to FIG. 1, the diameters 42 of holes 72 of metal boards 61A,61B are fitted to the diameters 44 of pins 62, for allowing the insertion by pressure only.

Thus, and referring again to FIG. 5, the plurality of pins 62, being fittingly threaded into holes 72, form a frame 48 for fixing wood boards 60A and 60B one to the other.

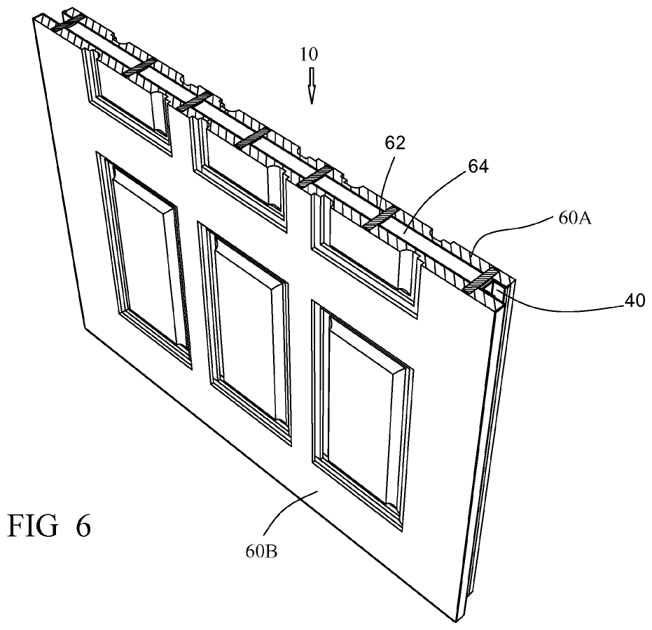

FIG. 6 is a perspective view of the security door of FIG. 1 being constructed, shown cut for viewing its character.

Wood boards 60A and 60B may be stuck one to the other by pins 62 (cut in the figure) only, without requiring fixing any of them to metal boards 61A or 61B.

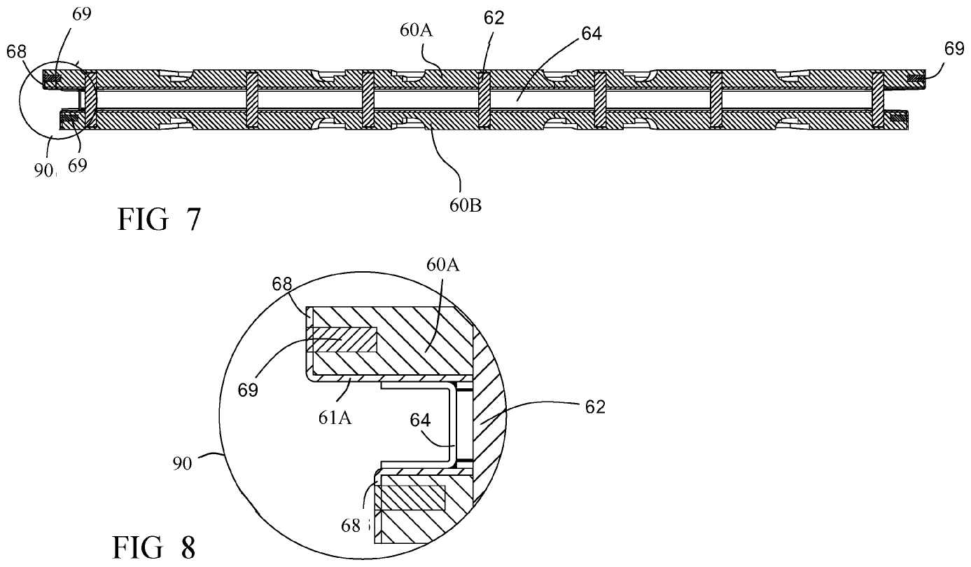

FIG. 7 is a side view of the security door of FIG. 1 being constructed.

FIG. 8 magnifies a portion of FIG. 7.

Each of wood boards 60A and 60B is significantly thicker than each of metal boards 61A and 61B, as wood boards 60A and 60B function for avoiding folding of the security door.

Metal boards 61A and 61B are characterized in avoiding separation of one away from the other by frame 64, against bolt 80 disposed in between. However without wood boards 60A and 60B, metal boards 61A and 61B as being significantly thin, would have been folded.

The wood boards and the metal boards are not fixed one to the other. Thus, differences of changes of size and shapes due to heating and cooling between wood and metal, does not harm the door.

Metal board 61A may include perpendicular folds 68, for housing wood board 60A. Folds 68 of metal board 61A may allow threading nails 69 into the thickness of wood board 60A.

Thus, in one aspect, the invention is directed to a security door (10), including:
two non-metal boards (60A,60B);
two metal boards (61A,61B) disposed between the two non-metal boards (60A,60B), and being fixed one to the other, while forming at least one gap (40) therebetween; and
a plurality of pins (62), each extending between the two non-metal boards (60A,60B), through the two metal boards (61A,61B), for fixing the two non-metal boards (60A,60B) one to the other.

The security door (10) may further include a metal frame (64), disposed between the two metal boards (61A,61B) and being fixed thereto, thereby providing the fixing of the two metal boards (61A,61B) one to the other and providing the gap (40) therebetween.

Each of the two non-metal boards (60A,60B) may be significantly thicker than each of the two metal boards (61A,61B), thereby the non-metal boards (60A,60B) are characterized for avoiding folding of the two metal boards (61A,61B).

The gap (40) may be shaped for inserting a bolt (80) thereinto, for bolting the security door (10).

The fixing of the two metal boards (61A,61B) one to the other may apply welding.

Each of the two non-metal boards (60A,60B) may include a plurality of depressions (74), and the fixing of the two non-metal boards (60A,60B) one to the other by the pins (62) may apply sticking the pins (62) into the depressions (74).

Each of the two metal boards (61A,61B) may include a plurality of holes (72), sized to the pins (62), for fittingly threading the pins (62) through the holes (72), thereby the pins (62) upon being threaded, form a frame (48) for fixing the non-metal boards (60A,60B) one to the other.

In the figures and/or description herein, the following reference numerals (Reference Signs List) have been mentioned:

numeral 10 denotes the security door according to one embodiment of the invention;
40: gap for inserting bolt 80;
60A,60B: non-metal boards;
61A,61B: metal boards;
62: pin;
64: metal frame;
68: fold in metal board;
69: nail;
70: fixing, such as by welding;
72: hole extending from side to side;
74: depression extending from the inner side, typically not reaching the outer side 94 of the wood board;
80: bolt;
90: zone;
94: out side of non-metal board 60A.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A security door, comprising:
two non-metal boards;
two metal boards disposed between said two non-metal boards, and being fixed one to the other, while forming at least one gap therebetween; and
a plurality of pins, each extending between said two non-metal boards, through said two metal boards, for fixing said two non-metal boards one to the other,
wherein said plurality of pins fixing said two non-metal boards one to the other are not fixed to said two metal boards.

2. The security door according to claim 1, further comprising:
a metal frame, disposed between said two metal boards and being fixed thereto, thereby providing said fixing of said two metal boards one to the other and providing said gap therebetween.

3. The security door according to claim 2, wherein said metal frame is not fixed to said plurality of pins.

4. The security door according to claim 1, thereby said two non-metal boards are fixed one to the other, and said two metal boards are fixed one to the other, whereas said non-metal boards are not fixed to said metal boards.

5. The security door according to claim 1, wherein each of said two non-metal boards is significantly thicker than each of said two metal boards, thereby said non-metal boards are characterized for avoiding folding of said two metal boards.

6. The security door according to claim 1, wherein said at least one gap is shaped for inserting a bolt thereinto, for bolting said security door.

7. The security door according to claim 1, wherein said fixing of said two metal boards one to the other comprises welding.

8. The security door according to claim 1,
wherein each of said two non-metal boards comprises a plurality of depressions, and
wherein said fixing of said two non-metal boards one to the other by said pins comprises sticking said pins into said depressions.

9. The security door according to claim 1, wherein each of said two metal boards comprises a plurality of holes, sized to said pins, for fittingly threading said pins through said holes, thereby said pins upon being threaded, form a frame for fixing said non-metal boards one to the other.
